(19) United States
(12) Patent Application Publication
(10) Pub. No.: US 2002/0069649 A1
(43) Pub. Date: Jun. 13, 2002

(54) Container for cryopreserved material

(75) Inventors: Stephen A. Buia, Hampton, NH (US); Alan J. Buckler, Arlington, MA (US); Mabel P. Buckler, Arlington, MA (US); Martin Lee Ferguson, Medford, MA (US); Eileen Ann Lonergan, Sanford, ME (US); Stephen V. Chasse, Franklin, MA (US)

Correspondence Address: FOLEY, HOAG & ELIOT, LLP, PATENT GROUP, ONE POST OFFICE SQUARE, BOSTON, MA, 02109, US

(73) Assignee: Ardais Corporation

(21) Appl. No.: 10/021,513

(22) Filed: Dec. 7, 2001

Related U.S. Application Data
(60) Provisional application No. 60/254,239, filed on Dec. 8, 2000.

(51) Int. Cl. F17C 1/00

(52) U.S. Cl. 62/45.1

(57) ABSTRACT

Containers that are suitable for long-term and efficient storage, tracking, and manual or robotic manipulation of cryopreserved biological materials, in particular human tissue samples, are disclosed herein. According to one exemplary embodiment disclosed herein, a container may include a receptacle and a plurality of projections. The receptacle may include a lower wall and a side wall. The side wall may have an inner surface. The plurality of projections may extend upward along and outward from the inner surface of the side wall. The plurality of projections may define a region for receiving a sample having an orientation and may be shaped and arranged to inhibit a change in the orientation of the sample when stored in the container.

### REFERENCE TO RELATED APPLICATIONS

This application claims priority to U.S. Provisional Application No. 60/254,239, filed Dec. 8, 2000, the contents of which are incorporated by reference herein.

### BACKGROUND

Cryopreservation or freezing at very low temperatures has been an effective method for long-term preservation of biological materials. The goal of cryopreservation is to preserve the structural integrity and viability of biological materials for an indefinite period of time.

Cryopreservation typically involves enclosing biological material within a freezing medium to be frozen and preserved in an ampoule or a tube. Because of their shape, these ampoules or tubes are difficult to stack, thereby impeding efficient storage and retrieval of the biological materials contained therein. As a result, standard storage vials are often stored in freezers using ordinary plastic bags or cardboard boxes. These conventional approaches to storage have proven to be inadequate for maintaining and tracking a large inventory of specimens.

Further, cataloging specimens in these standard storage vials is often difficult and time consuming. Usually, labeling of the specimens consists of writing notes on the side of an ampoule or tube by hand. Upon freezing and thawing several times, the writing can become illegible. Consequently, frozen specimens are sometimes misused, misplaced or even lost.

Accordingly, there remains a need in the art for a cryopreservation container suitable for efficient long-term storage, tracking, and retrieval of biological materials, and that also overcomes the current difficulties associated with standard storage vials.

### SUMMARY

Containers that are suitable for long-term and efficient storage, tracking, and manual or robotic manipulation of cryopreserved biological materials, in particular human tissue samples, are disclosed herein. The containers disclosed herein can be used as a part of an automated inventory management system for frozen tissue samples.

According to one exemplary embodiment disclosed herein, a container may include a receptacle and a plurality of projections. The receptacle may include a lower wall and a side wall. The side wall may have an inner surface. The plurality of projections may extend upward along and outward from the inner surface of the side wall. The plurality of projections may define a region for receiving a sample having an orientation and may be shaped and arranged to inhibit a change in the orientation of the sample when stored in the container.

According to another exemplary embodiment disclosed herein, a container may include a base, a receptacle, a cover, a marking panel, and a plurality of projections. The base may have a top surface and a first end. The receptacle may extend upward from the top surface of the base and have an inner surface and a cross-section that has a substantially circular shape. The cover may threadably engage the receptacle and form a fluid-tight seal with the receptacle for confining a sample within the receptacle and inhibiting desiccation of the sample. The marking panel may extend from the first end of the base and may have a substantially planar surface for receiving identifying indicia. The plurality of projections may extend upward along and outward from the inner surface of the receptacle and upward from the top surface of the base. A projection may have at least a first side, a second side, and a third side, in which the first side faces the inner surface of the receptacle, the second and third sides are substantially planar, and the second side is oriented in a direction perpendicular to the third side. The plurality of projections may be shaped and arranged to inhibit a change in the orientation of a sample when stored in the container.

According to another exemplary embodiment disclosed herein, a base may have a bottom surface. The bottom surface may have a plurality of protrusions projecting downward therefrom. The protrusions may be shaped and arranged to permit an identification panel containing identifying indicia to be removably and securely attached to the container.

### BRIEF DESCRIPTION OF THE DRAWINGS

These and other features of the containers disclosed herein will be more fully understood by reference to the following detailed description in conjunction with the attached drawings in which like reference numerals refer to like elements throughout the different views. While the drawings illustrate principles of the containers disclosed herein, they are not drawn to scale, but show only relative dimensions.

FIG. 1A is a top perspective view of an embodiment of the cryopreservation container disclosed herein.

FIG. 1B is a bottom perspective view of the cryopreservation container in FIG. 1A.

FIG. 2A is a top view of a cover.

FIG. 2B is a view of the underside of the cover in FIG. 2A.

FIG. 2C is a sectional view of the cover of FIG. 2A along line C-C, showing internal threads.

FIG. 3A is top view of the cryopreservation container of FIG. 1A.

FIG. 3B is a sectional view of the bottom of the cryopreservation container of FIGURE 1A.

FIG. 3C is a sectional view of the cryopreservation container of FIG. 3A along line C-C, showing external threads.

FIG. 4 is a sectional view of the cryopreservation container of FIG. 3A along line A-A, illustrating a cover attached to the receptacle.

FIG. 5 is a sectional view of the cryopreservation container of FIG. 1A, showing a flat marking surface.

FIG. 6 is a top view of a receptacle, showing an alternative configuration of projections.

FIG. 7A is a top perspective view of another embodiment of the cryopreservation container disclosed herein.

FIG. 7B is a bottom perspective view of the cryopreservation container in FIG. 7A.

### DETAILED DESCRIPTION OF EXEMPLARY EMBODIMENTS

Certain exemplary embodiments will now be described to provide an overall understanding of the principles of the containers disclosed herein. One or more examples of these embodiments are illustrated in the drawings. Those of ordinary skill in the art will understand that the containers described herein can be adapted and modified to provide instruments and methods for other suitable applications and that other additions and modifications can be made without departing from the scope of the containers disclosed herein. For example, the features illustrated or described as part of one embodiment or one drawing can be used on another embodiment or another drawing to yield yet another embodiment. Such modifications and variations are intended to be included within the scope of the present disclosure.

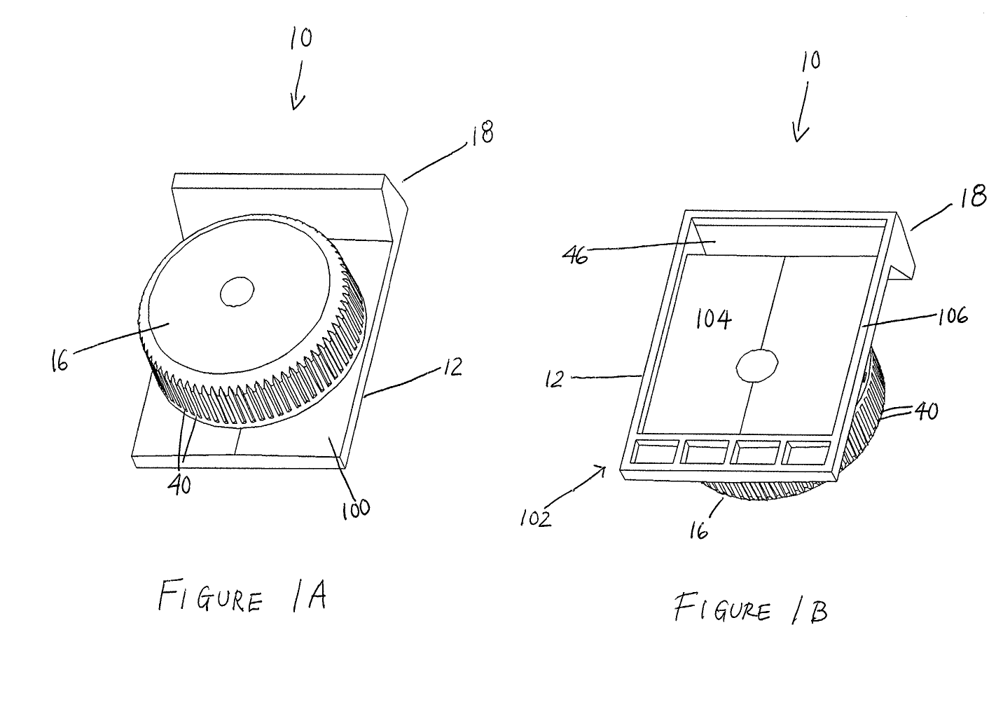

An exemplary embodiment of a container for storing cryopreserved material is illustrated in FIGS. 1-7. As shown in FIGS. 1-7, the container 10 includes a base 12, a receptacle 14, a cover 16, and a marking panel 18.

As shown in FIGS. 1A and 1B, the base 12 has a substantially rectangular shape. The base 12 may, however, have a variety of shapes. For example, the base 12 may have the shape of any type of polygon, including a square, a rectangle, and a triangle, or the shape of any type of oval, including an ellipse and a circle.

As shown in FIGS. 1A and 1B, the base 12 has a substantially planar top surface 100 and a bottom surface 102 that has a recessed interior portion 104 and a raised exterior portion 106. The top and bottom surfaces 100, 102 of the base may have a variety of other constructions, as provided below.

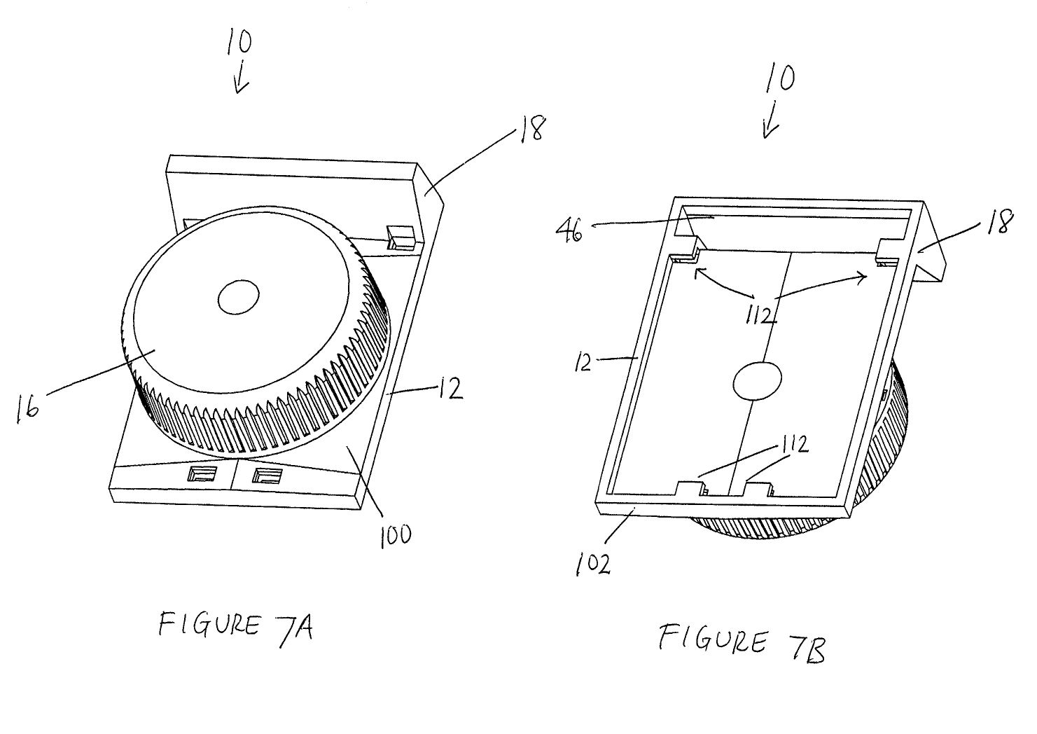

An alternative construction of the base 12 is illustrated in FIGS. 7A and 7B. As shown in FIGS. 7A and 7B, the bottom surface 102 of the base 12 may include protrusions 112 shaped and arranged to permit an identification panel containing indicia identifying the contents of the container 10 to be securely and removably attached to the container 10. The identification panel may be any structure known to one of ordinary skill in the art for containing indicia, including, but not limited to, impressions or protrusions in any type of surface, such as writing on paper, embossing on plastic, or a bar code designed to be read by an optical scanner.

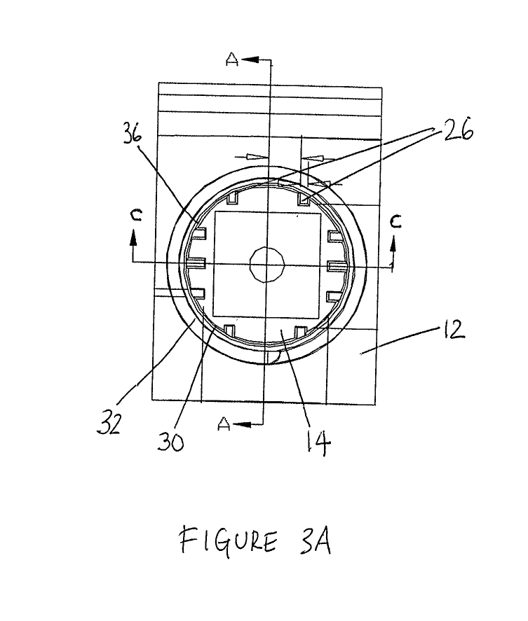

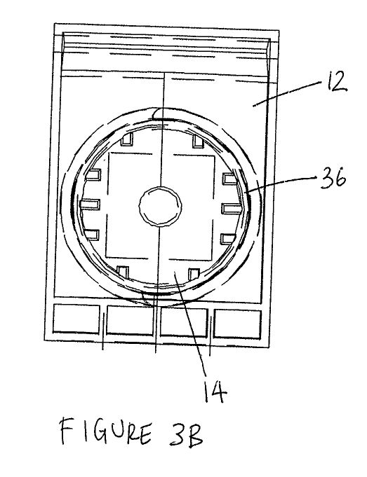

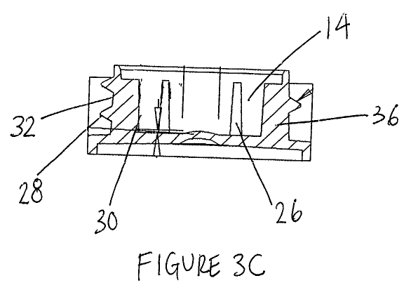

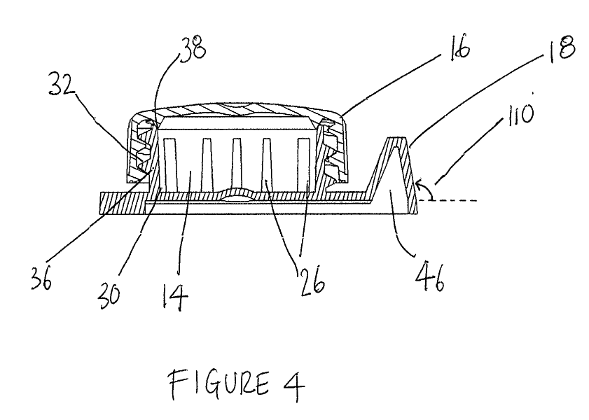

As shown in FIGS. 3A, 3B, and 3C, the container 10 includes a receptacle 14. The receptacle 14 may be formed integral with the base 12, or the receptacle may be formed separately and attached to the base using any securing means known to one of ordinary skill in the art, including, but not limited to, an adhesive and a weld. Apart from being permanently attached to the container 10, the receptacle 14 may be removably and replaceably attached to the container 10.

As shown in FIGS. 3A, 3B, and 3C, the receptacle 14 is defined by a wall 36 that extends upward from the top surface 100 of the base 12. The wall 36 may extend in a direction substantially perpendicular to the base 12, and the receptacle 14 may have cross-section that is substantially circular and consistent in diameter throughout the upward extent of the wall 36. The receptacle 14 may, however, have a variety of other constructions. The receptacle 14 may have the shape of a cylinder, a cone, a bowl, or a box. The receptacle 14 may have a cross-section that has the shape of any type of polygon, including a square, a rectangle, and a triangle, or any type of oval, including a circle and an ellipse. Moreover, the receptacle 14 may have a cross-section that has a first extent that varies over the upward extent of the wall 36. For example, the receptacle 14 may have a circular cross-section characterized by a diameter that varies over the upward extent of the wall 14. Additionally, the receptacle 14 may have a cross-section whose basic shape varies over the upward extent of the wall. For example, the receptacle 14 may have a square cross-section for a first portion of its height and a circular cross-section for a second portion of its height.

In alternative embodiments, the container 10 may be constructed without a base 12. In these embodiments, and other embodiments in which the receptacle 14 is separate or removable from the base 12, the receptacle 14 is defined by a lower wall and a side wall. In those embodiments in which the receptacle 14 is attached to the base 12, the top surface 100 of the base 12 provides the lower wall of the receptacle 14.

As shown in FIGS. 3A, 3B, and 3C, projections 26 are enclosed within the wall 36 of the receptacle 14. The projections 26 are shaped and arrange to inhibit a change in the orientation and position of a sample within the container 10. The wall 36 has an inner surface 30 and an outer surface 32. As shown in FIGS. 3A, 3B, and 3C, the projections 26 may extend upward from the top surface 100 of the base 12 along the inner surface 30 of the wall 36. The projections 26 may also have a variety of other positions. For example, the projections 26 may not be contiguous with the base 12, but may simply project upward along and outward from the inner surface 30 of the wall 36. Alternately, the projections 26 may not be contiguous with the wall 36, but may simply project upward from the top surface 100 of the base 12. The projections 26 may be formed integral with the base 12, the wall 36, or both the base 12 and the wall 36. Alternately, the projections 26 may be formed separately and attached to the base 12, the wall 36, or both the base 12 and the wall 36 using any means known to one of ordinary skill in the art, including, but not limited to, an adhesive or a weld. Apart from being permanently attached to the container 10, the projections 26 may be removably and replaceably attached to the container 10.

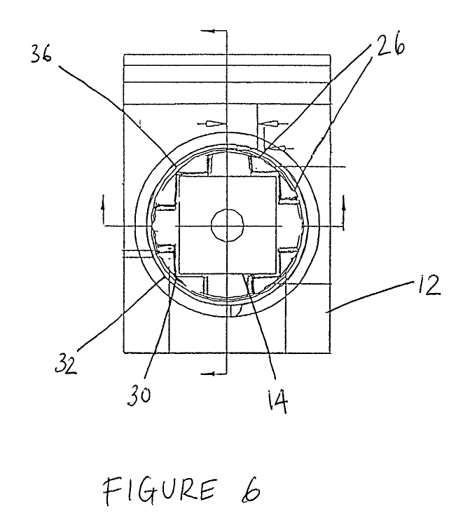

As shown in FIGS. 3A, 3B, 3C and 6, the projections 26 decrease the space within the receptacle 14, thereby defining a region for receiving a sample. The projections 26 are shaped and arranged within the receptacle 14 to inhibit a sample from rotating from a desired orientation and moving from a desired position. The projections 26 may have a variety of shapes and arrangements in addition to those shown in FIGS. 3A, 3B, 3C, and 6. For example, the projections 26 may have cross-sections that are hemispherical. Additionally, the projections 26 may extend along the entire upward extent of the wall 36, or the projections 26 may extend along only a portion of the upward extent of the wall 36 in order to accommodate samples having different shapes. For example, in one embodiment, as shown in FIG. 3C, the projections 26 may extend only partway along the upward extent of the wall 36 in order to accommodate samples that have mushroom-like shapes.

As shown in FIGS. 1A and 1B, the container 10 includes a cover 16 removably attached to the container 10 for confining the sample within the container 10.

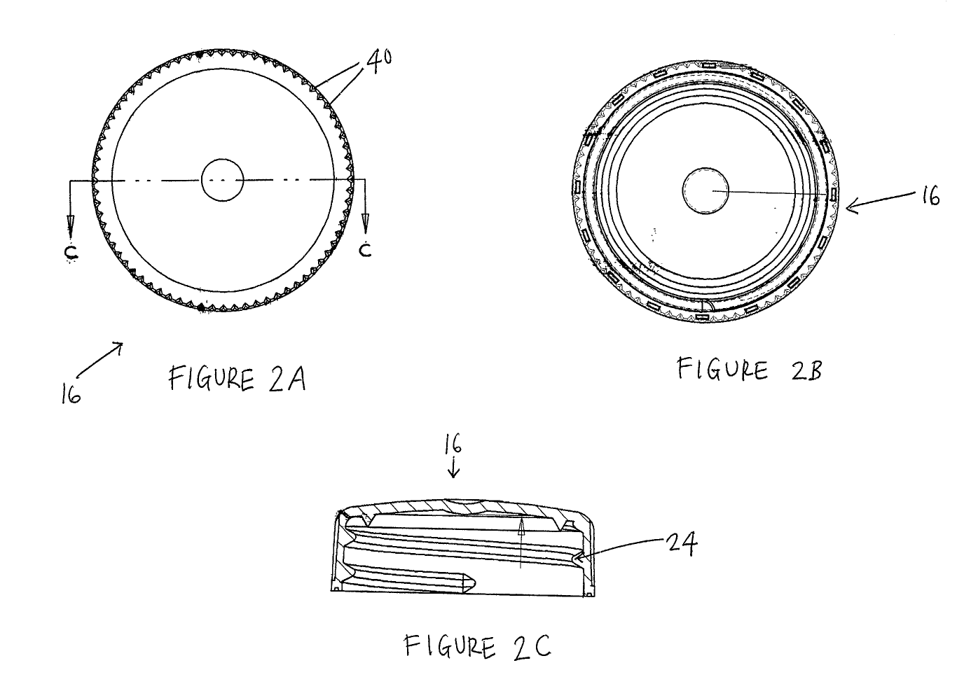

As shown in FIG. 2C, the cover 16 may threadably engage the container 10. The cover 16 may have internal threads 24 that engage external threads 28 formed on the outer surface 32 of the wall 36 of the receptacle 14. Rotation of the cover 16 relative to the base 12 and the receptacle 14 may be used for opening and closing the container 10. Rotation may occur in either the clockwise or counter-clockwise direction. Preferably, rotation in one direction is used to open the container 10, and rotation in the opposite direction is used to close the container 10. Preferably, the rotation is not greater that 360° in either direction to open or close the container, and most preferably the rotation is 270°.

Additionally, the cover 16 may engage the receptacle 14 to provide a fluid-tight seal, thereby inhibiting desiccation of the contents. Also, the cover may engage the receptacle so as to provide a seal that withstands at least approximately 80 kPa of internal pressure, and preferably at least approximately 95 kPa of internal pressure.

The cover 16 may be removably attached to the receptacle 14 by using any structure known to one of ordinary skill in the art, including, but not limited to, a press-fit or a snap-on mechanism.

The cover 16 may also have a variety of shapes, provided that it is mated to the receptacle 14 to confine the sample within the container 10. The cover 16 may be shaped so as to have a portion that fits around the outer surface of the wall 36, or the cover may be shaped so as to have a portion that fits inside the wall 36. For example, as shown in FIG. 4, the cover 16 may have a lip 38 that engages the inner surface 30 of the wall 36 of the receptacle portion 14 in a substantially fluid-tight seal to inhibit degradation of a sample in the container 10. As shown in FIGS. 1A and 1B, the outer surface of the cover 16 may contain serrations 40 to facilitate gripping or robotic manipulation.

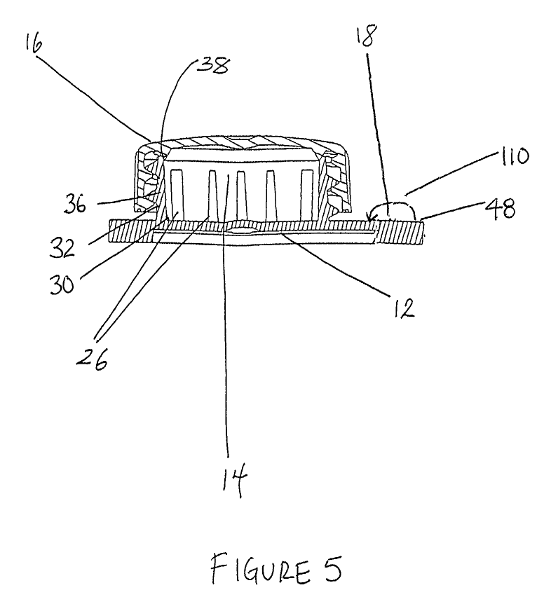

As shown in FIGS. 4 and 5, the container 10 includes a marking panel 18 for receiving indicia identifying the contents of the container 10. The marking panel 18 may be formed integrally with the base 12, or may be formed separately and attached to the base using any means known to one of ordinary skill in the art, including, but not limited to, an adhesive and a weld. Apart from being permanently attached to the container 10, the marking panel 18 may be removably and replaceably attached to the container 10. The marking panel 18 may include a substantially smooth surface to facilitate observation of identifying indicia positioned thereon. As shown in FIG. 4, in one embodiment, the marking panel 18 may form an angle 110 with the top surface 100 of the base 12, and may be formed by a recess 46 in the underside of the base 12. Alternative constructions of the marking panel 18 and alternative angles 110 are possible. For example, the marking panel may form any angle 110 with the top surface 100 that is greater than 90 degrees. Additionally, as shown in FIG. 5, in another embodiment, the marking panel 18 may be flat 48, that is, may form an angle 110 of 180 degrees with the top surface 100 of the base 12, and may be formed by extending one side of the base 12.

The base 12, receptacle 14, and cover 16 are constructed from polymeric material. The cover 16 may be constructed from a different polymeric material than the receptacle 14 to inhibit the binding of the receptacle 14 and the cover 16 at low temperatures. For example, the cover 16 may be made of polyethylene, and the receptacle 14 may be made of polypropylene. The container 10 may also be fabricated from any other material suitable for cryopreservation, including, but not limited to, glass, stainless steel, and any other inert metal.

The base 12, receptacle 14, and cover 16 may be constructed to be transparent to facilitate observation and identification of a sample within the container 10. Alternately, the base 12, receptacle 14, and cover 16 may be constructed to be opaque to prevent light from degrading a sample within the container 10 during storage.

The receptacle 14 and the cover 16 may be coated with one or more layers of one or more biologically inert materials to facilitate cryopreservation in various chemical environments. The receptacle and the cover may also be coated with one or more layers of one or more biologically inert materials to enhance resistance to corrosion by substances used in cryopreservation.

The containers disclosed herein are compatible with a variety of biological samples. Suitable biological samples for the containers disclosed herein include, but are not limited to, samples derived from human tissue, animal tissue, and plant tissue by any means known to one of ordinary skill in the art.

While the containers disclosed herein have been particularly shown and described with reference to the exemplary embodiments thereof, those of ordinary skill in the art will understand that various changes may be made in the form and details herein without departing from the spirit and scope of the disclosure. Those of ordinary skill in the art will recognize or be able to ascertain many equivalents to the exemplary embodiments described specifically herein by using no more than routine experimentation. Such equivalents are intended to be encompassed by the scope of the present disclosure and the appended claims.

We claim

1. A container for storing a sample, the container comprising:
a receptacle having a lower wall and a side wall, the side wall having an inner surface, and
a plurality of projections extending upward along and outward from the inner surface of the side wall, the projections defining a region for receiving a sample having an orientation, the projections being shaped and arranged to inhibit a change in the orientation of the sample when stored in the container.

2. The container of claim 1 wherein each of the projections has a cross-section having at least a first side, a second side, and a third side, the first side facing the inner surface of the receptacle, the second and third sides being substantially planar.

3. The container of claim 2 wherein the second side is oriented in a direction substantially perpendicular to the third side.

4. The container of claim 1 wherein each of the projections has a cross-section having a substantially hemispherical shape.

5. The container of claim 1 wherein the projections are formed integrally with the receptacle.

6. The container of claim 1 wherein the projections are removably and replaceably attached to the receptacle.

7. The container of claim 1 wherein the receptacle has a height and a cross-section having a first extent, the first extent of the cross-section being substantially constant over the height.

8. The container of claim 1, wherein the receptacle has a height and a cross-section having a first extent, the first extent of the cross-section varying over the height.

9. The container of claim 7 wherein the receptacle has a cross-section having an oval shape.

10. The container of claim 1 further comprising a cover for confining the sample within the receptacle, the cover being removably attached to the receptacle.

11. The container of claim 10 wherein the cover engages the receptacle to form a fluid-tight seal.

12. The container of claim 10 wherein the cover threadably engages the receptacle.

13. The container of claim 1 further comprising a base having a top surface, wherein the sidewall extends upward from the top surface of the base.

14. The container of claim 13 wherein the sidewall extends in a direction substantially perpendicular from the top surface of the base.

15. The container of claim 13 wherein the projections extend upward from the top surface of the base.

16. The container of claim 10 wherein the projections extend in a direction substantially perpendicular from the top surface of the base.

17. The container of claim 13 wherein the base has a first end and the container further comprises a marking panel extending from the first end of the base, the marking panel having a substantially smooth surface for receiving identifying indicia.

18. The container of claim 17 wherein the marking panel forms an angle with the top surface of the base, the angle being at least 90 degrees.

19. The container of claim 17 wherein the marking panel is formed integrally with the base.

20. The container of claim 13 wherein the base has a top surface and a bottom surface, the bottom surface having a plurality of protrusions extending downward therefrom, the protrusions being shaped and arranged to permit an identification panel containing identifying indicia to be removably and securely attached to the container.

21. The container of claim 13 wherein the base has a top surface and a bottom surface, the bottom surface having an interior recessed portion and an exterior raised portion, the exterior raised portion having a plurality of protrusions extending outward therefrom and downward toward the recessed portion, the protrusions being shaped and arranged to permit an identification panel containing identifying indicia to be removably and securely attached to the container.

22. A container for storing a sample, the container comprising:
a base having a top surface and a first end,
a receptacle extending upward from the top surface of the base, the receptacle having an inner surface and a cross-section having a substantially circular shape,
a cover threadably engaging the receptacle and forming a fluid-tight seal therewith for confining the sample within the receptacle and inhibiting desiccation thereof,
a marking panel extending from the first end of the base, the marking panel having a substantially planar surface for receiving identifying indicia, and
a plurality of projections extending upward along and outward from the inner surface of the receptacle and upward from the top surface of the base, each of the projections having at least a first side, a second side, and a third side, the first side facing the inner surface of the receptacle, the second and third sides being substantially planar, the second side being oriented in a direction substantially perpendicular to the third side, the projections being shaped and arranged to inhibit a change in the orientation of the sample when stored in the container.
